(19) United States
(12) Patent Application Publication
(10) Pub. No.: US 2005/0203270 A1
(43) Pub. Date: Sep. 15, 2005

(54) Functionalized polymers and their biomedical and pharmaceutical uses

(75) Inventors: Patrice Hildgen, Montreal (CA); Gregoire Leclair, Montreal (CA); Richard Quesnel, Montreal (CA)

Correspondence Address: MERCHANT & GOULD PC, P.O. BOX 2903, MINNEAPOLIS, MN, 55402-0903, US

(73) Assignee: Valorisation-Recherche, Societe en Commandite, Montreal, Quebec, QC (CA)

(21) Appl. No.: 10/510,407

(22) PCT Filed: Apr. 3, 2003
(86) PCT No.: PCT/CA03/00487

§ 371 Date: Apr. 22, 2005

Related U.S. Application Data
(60) Provisional application No. 60/369,808, filed on Apr. 5, 2002.

(51) Int. Cl. C08G 63/08

(52) U.S. Cl. 528/354

(57) ABSTRACT

Disclosed is a polymer of the formula I: 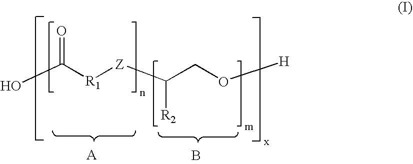 wherein: Z is —O— or —NH—;
R₁ represents a non-functional backbone of a hydroxy acid or amino acid derived from a cyclic ester or diester or cyclic amide or diamide monomer (A);
R₂ represents a non-functional chain derived from an epoxide monomer (B), said chain ending with a graftable hydroxy or carboxylic group; n is the number of units derived from the monomers (A); m is the number of units derived from the monomers (B); and x is equal to n+m, the ratio m/x ranging from 0.005 to 0.30. Also disclosed is a process of preparing this functionalizable polymer to the hydroxy or carboxylic groups of which can be grafted a compound selected from the group consisting of: ligands specific to cellular receptors, such as Selectine E; lipids; peptides; polyethers; polyacrylates; natural polymers; polyosides; antigens or antibodies; salen; and cyclodextrins. The so grafted polymer can be used as carried or excipient in the biomedical and pharmaceutical fields.

### BACKGROUND OF THE INVENTION

A) Field of the Invention

The present invention relates to new functionalized polymers that can be used to prepare functionalized polymers particularly useful in the biomedical and pharmaceutical fields.

The invention also relates to the preparation of these functionalizable polymers.

The invention further relates to the functionalized polymers prepared from said functionalizable polymers.

B) Brief Description of the Prior Art

It is known that some alphahydroxy acid polyesters have been used during the past twenty years in the biomedical and pharmaceutical fields. They are used essentially because of their ability to degrade by hydrolysis into corresponding hydroxy acids which are already present in some metabolic pathways.

FIG. 1 identified as “prior art” illustrates three of these known polyesters. In the formulae given in this FIG. 1, m and n are selected so that the average molecular weight of the corresponding polyester(s) ranges from 1,000 to 80,000.

If these alphahydroxy acid polyesters in the form of macromolecules (viz. PLA, PLGA or PCL) are interesting, they unfortunately have also some undesired properties, such as a high hydrophobicity and a negative zeta potential when used in the form of microparticles or nanoparticles. Such also gives them a high reactivity with respect to the reticulo-endothelial system.

To overcome the above mentioned problems, it has already been suggested to prepare and use polymers having a polymeric backbone with lateral groups such as hydroxyl groups, on which active molecules can be grafted by a covalent bond (prodrug).

As examples of such functionalizable polymers and their potential uses, reference can made to those described in U.S. Pat. No. 6,093,792 of 2000 (GROSS et al), which are prepared by reaction between a first comonomer selected among lactones, lactides, lactams, thiolactones and non-functionalized cyclic carbonates, and a second, functionalized cyclic carbonate comonomer to which an active substance such a protein, an anticancer drug or an antihypertensive drug, can be linked.

As other examples of such functionalizable polymers, reference can also be made to the PLA-based polymers referred to in column 1 of the above mentioned U.S. Pat. No. 6,093,792.

PLA-based polymers having lateral carboxylic groups have already been prepared by copolymerisation with malic acid. Such malic-co-lactic polymers with pendant groups can be grafted to various molecules such as other polymers, lipids, ionisable function or antibodies. However, the preparation of these polymers requires numerous steps, including inter alia a necessary protection of the carboxylic groups during polymerization. Another drawback is the fact that the number of reticulation bonds that may be obtained by transesterification is difficult to determine.

PLA-based polymers having lateral amino groups have also been prepared by copolymerization with lysine. In addition to requiring numerous steps again, this preparation leads to products containing lysine, which is known to be immunogenic.

### SUMMARY OF THE INVENTION

It has now been found that new functionalizable polymers of very interesting structure and properties can be prepared by a very simple process comprising a first and second basic steps plus an optional third step, which are easy to carry out with high yield and thus overcome most of the drawbacks of the existing processes used so far for the preparation of functionalizable PLA-based polymers.

Thus, a first object of the present invention is to provide new functionalizable polymers of formula I: 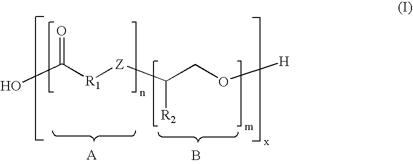
wherein:
Z is —O— or —NH—;
R₁ represents a non-functional backbone of a hydroxy acid or amino acid derived from a cyclic ester or diester or cyclic amide or diamide monomer (A);
R₂ represents a non-functional chain derived from an epoxide monomer (B), this chain ending with a graftable hydroxy or carboxylic group;
n is the number of units derived from the monomers (A);
m is the number of units derived from the monomers (B); and
x is equal to n+m;
   the ratio mix ranging from 0.005 to 0.30.

A second object of the invention is to provide a very single yet efficient process for preparing the above mentioned polymers of formula I, which comprises the steps of:
a) reacting at least one monomer A as defined hereinabove with at least one epoxide of formula III 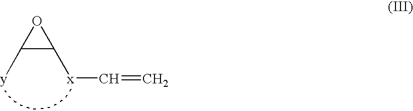
   wherein:
X is a non-functional chain optionally containing one or more heteroatoms but no ester or amide link; and
Y is H, alkyl or phenyl;
X and Y being optionally linked to each other as shown in dotted lines,
   b) subjecting the polymer obtained in step a) to an oxidation to convert the —CH═CH₂ groups into corresponding —CH₂CH₂OH groups; and
   c) optionally subjecting the polymer obtained in step b) to another oxidation with a Jones mixture to convert the —CH₂CH₂OH groups into corresponding —CH₂COOH groups.

As can be appreciated, every one of these three steps is “conventional” and easy to carry out, and leads to high yields.

A third object of the invention is to provide functionalized polymers consisting of functionalizable polymers of the formula I as defined hereinabove, to the hydroxy or carboxylic groups of which has been grafted a compound selected from the group consisting of:
ligands specific to cellular receptors, such as Selectines E and P, integrins, PGP, VECAM, ICAM, CD34, phosphatidylcholine receptors, nervous system receptors, etc. . . . ;
lipids;
peptides;
polyethers;
polyacrylates;
natural polymers;
polyosides;
antigens or antibodies;
salen; and
cyclodextrins.

The invention and its advantages will be better understood upon reading the following non restrictive detailed description made with reference to the accompanying drawings.

### BRIEF DESCRIPTION OF THE DRAWINGS

FIG. 1 identified as “prior art” is a representation of three known alphahydroxy acid polyesters, namely polyactid acid (PLA), polylactic-co-glycolic acid (PLGA) and poly-caprolactone (PGL).

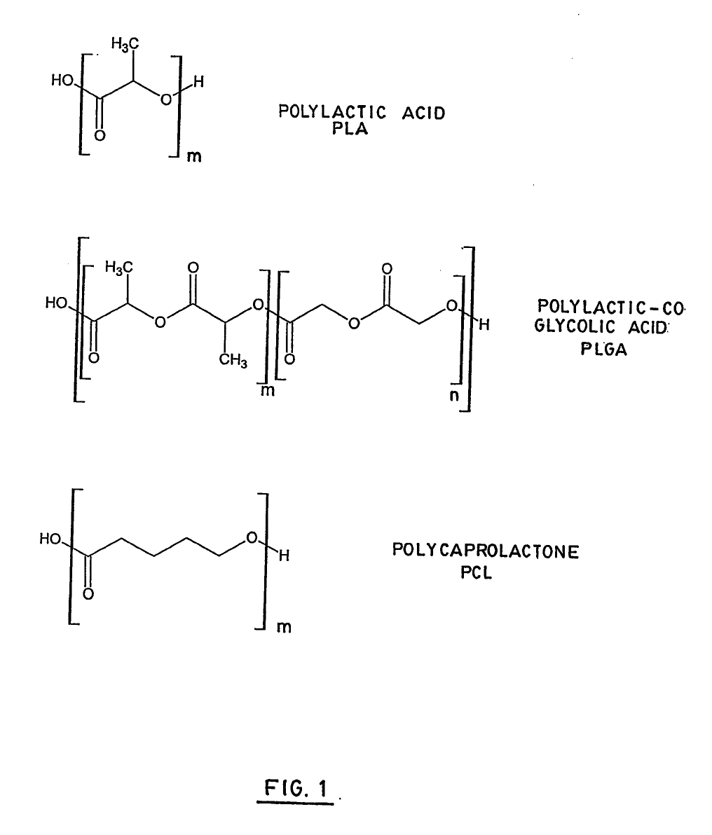

FIG. 2 is a schematic representation of a potential use of a polymer according to the invention as a carrier to a ligand specific to Selectine E.

FIG. 3 is a schematic representative of the three steps of the process used to prepare the functionalizable polymers disclosed in Example 1, functionalizable.

FIG. 4 is the formula of an example of methoxy-PEG based polymer according to the invention.

FIG. 5 is the formula of an example of cross-linked PEG-based polymer according to the invention.

### DETAILED DESCRIPTION OF THE INVENTION

As aforesaid, the functionalized polymer of formula I according to the invention consists of n units derived from a corresponding number of cyclic ester or diester or cyclic amine or diamine monomers (A), and m units derived from a corresponding number of epoxide monomers (B).

In the above formula I, the number and respective position of the units derived from the monomers (A) and those derived from the monomers (B) may substantially vary. As a matter of fact, they may vary in a random manner and the resulting polymers may be of different structure, like, for example, the following one:
AAABAABAAABBAAABAAAAABBA

As non restrictive examples of cyclic ester or diester monomers (A) usable to prepare the polymers of formula I wherein Z is —O—, reference can be made to:
dioxanediones of the following formula A1, such as glycolide, dilactide or glycolic lactide;
lactones of the following formula A2, including β-lactones, γ-lactones, δ-valerolactone, and ε-caprolactone; and
dioxanones of the following formula A3.

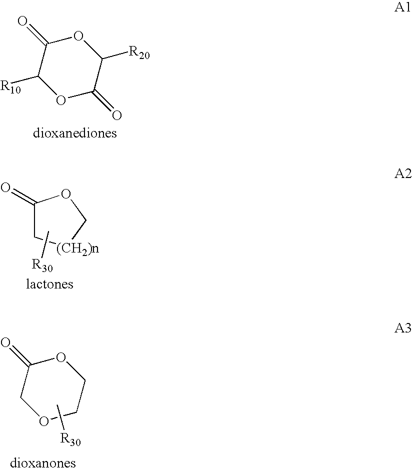

In the above formulae A1, A2 and A3, R₁₀ and R₂₀ are preferably H or C₁-C₄-alkyl, especially methyl, and R₃₀ is H or a hydrocarbon group, preferably a C₁-C₄ alkyl, that may be located at different positions.

As non-restrictive examples of cyclic amide or diamide monomers (A) usable to prepare the polymers of formula I where Z is —NH—, reference can be made to:
lactones, including β-lactones, γ-lactones, and ε-lactams; and
dilactams, such as cyclic diglycine.

As non-restrictive examples of epoxide monomers (B), reference can be made to those of formula II: 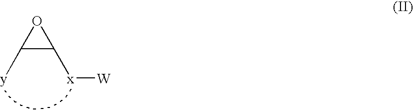
wherein:
X is a non-functional chain optionally containing one or more heteroatoms but no ester or amide link;
W is —CH₂CH₂OH or —CH₂COOH; and
Y is H, C1-C4-alkyl or phenyl;
X and Y being optionally linked to each other as shown in dotted lines.

As non-restrictive examples of epoxide monomers (B) of formula II, reference can be made to the following compounds:
allyl glycidyl ether;
methyl vinyl glycidyl amine;
1,2-epoxy 7-octene;
1-vinyl or alkyl 3,4-epoxy cyclohexane; and
4′-vinyl phenyl glycidyl ether.

In the above formula I, R₁, R₂, n, m and x are advantageously selected so that the average molecular weight of the polymer ranges from 1,000 to 50,000.

In the above formula I, it is also important that the ratio of the number of units derived from monomers (B) to the total of units derived from both the monomers (A) and (B), be ranging from 0.005 to 0.30. In other words, the molar ratio mix must range from 0.005 to 0.30. If this ratio exceeds 0.30, the obtained polymers may loose most of its advantageous properties.

The functionalizable polymers of formula I can be prepared in a very interesting and efficient manner by the process disclosed hereinabove, which comprises two or three steps depending on whether R₂ has to end with a graftable hydroxy group or a graftable carboxylid group.

The first step comprises mixing together either one or several monomers (A) with one or several epoxide monomers (B). The so prepared mixture is then heated at a temperature higher than 100° C. in the presence of a suitable ring opening catalyst. As examples of such catalyst, reference can be made to tin catalyst such tetraphenyl tin, tin hexanoate or tin octanoate. The polymer obtained at the end of this step can then be recovered and purified. Such a recovering and purification may include a washing and a drying or lyophilization.

The way this first step can be carried out is rather conventional. In this connection, reference can be made to the contents of U.S. Pat. No. 4,664,038 of 1987 (PROTZMAN) and of international laid-open application No. WO 03/000766 of 2003 (SHASTRI).

The second step of the process comprises converting into alcohols the double bonds W located at the free ends of the non-functional chains X of the units derived from the monomer (B) (see the formula II hereinabove) of the base polymer by means of an oxidizing agent. As oxidizing agent, use can be made of hydrogen peroxide. Alternatively and preferably, use can also be made of other “milder” oxidation agents. Thus, for example, the oxidation can be made under mild condition, by a hydroboration at low temperature. The so obtained alcohol groups are ideal sites for grafting.

If necessary, a third step may be carried out, which consists of converting the alcohol groups into carboxylic groups by oxidation with a Jones mixture or with potassium permanganate. The so obtained carboxylic groups offer other possibilities for grafting.

This process can be advantageously scaled-up without formation of reaction residues during any one of its steps, and the prepared polymers can be easily recovered and purified.

As aforesaid, the main advantage of this process is that it is quite simple and very efficient. The only residues that may be present are actually traces of the monomers used as starting materials, which may have not reacted. Moreover, the obtained polymers are easy to recovered and purified by washing, thereby avoiding the necessity of chromatography or other more elaborate purification and/or extraction processes.

The functionalizable polymers of formula I that are so obtained, are of a great utility. As aforesaid, they can be functionalized by grafting to their free hydroxy or carboxylic groups, any compound of interest like those listed hereinabove in the Summary of the Invention. Amongst these compounds, reference can particularly be made to biomedically or pharmaceutically active substances.

Such a grafting can be achieved by providing the compounds of interest with groups “compatible” with the free hydroxy or carboxylic groups of the polymers of formula I. In the case where the polymer to be grafted contains free hydroxy group, the compatible group may be an alkoyl chloride group:

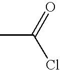

Other methods of grafting can also be used, including formation of ester or amide bonds and polymerization with an ultraviolet (UV) source.

Of course, the nature and type of compounds to be grafted depend on the intended uses of the resulting functionalized polymers.

Thus, the functionalizable polymers of formula I according to the invention can be used for the preparation of functionalized polymers having a vast amount of potential applications, including for example:
bioadhesive carriers for disorders in which a local released is preferred as opposed to a general administration (anti-cancerous, anti-inflammatory . . . );
circulating carriers for disorders in which an intravenous release in a narrow therapeutic window is required or a unique dosage is required (i.e. AIDS, anti-cancer (leukemia), antiarrythmic . . . );
cross-linked polymers for tissue regeneration or cell culture or as biocompatible and biodegradable excipients in tablets, capsules, etc. . . . ; and
lipid-like polymers for the fabrication of oral forms to enhance the bioavailability peptides.

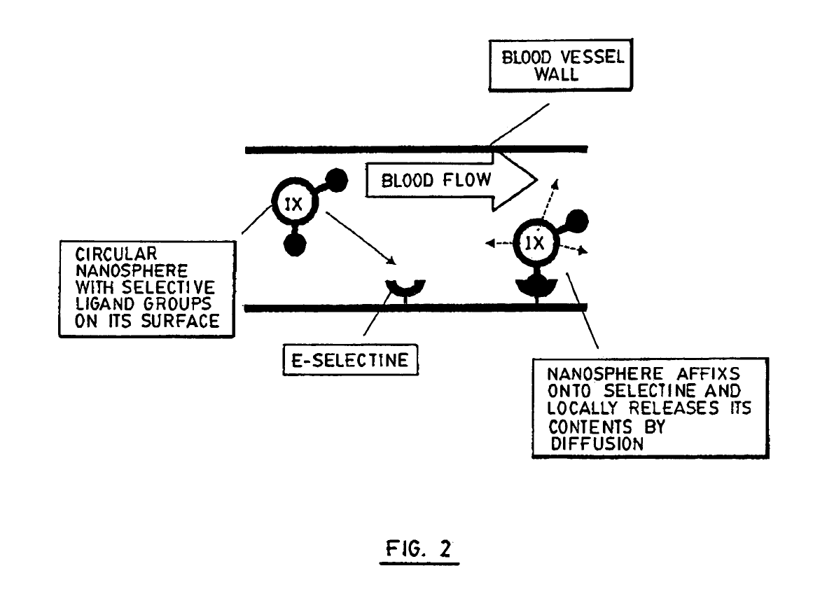

One of the advantages of the invention is that the so prepared polymers, when used as carriers, may be in the form of nanospheres (100 nm, and higher), thereby allowing delivery of the compounds that may be grafted to them or only embedded therein. Such is particularly interesting when the compounds are active substances like, for example, a ligand specific to Selectine E which must be delivered to regions wherein selective is expressed (see FIG. 2).

### EXAMPLE 1

Dilactide and alkyl glycidyl ether were mixed in a round bottom flask with tetraphenyltin as catalyst. The mixture was heated at 180C for 6 hours. The resulting polymer was dissolved in ethylacetate and purified by precipitation in water.

The double bonds of the polymer were then oxidized to OH by hydroboration and the OH groups were subsequently converted to carboxylic groups by oxidation with a Jones mixture (H₂SO₄, CrO₃ and H₂O).

The above mentioned hydroboration was carried out with BH₃ in tetrahydrofuran at 0° C. for 3 h. Then, water, sodium hydroxide and peroxide were added for 30 minutes. The resulting hydroxylated polymer was recovered by extraction with chloroform.

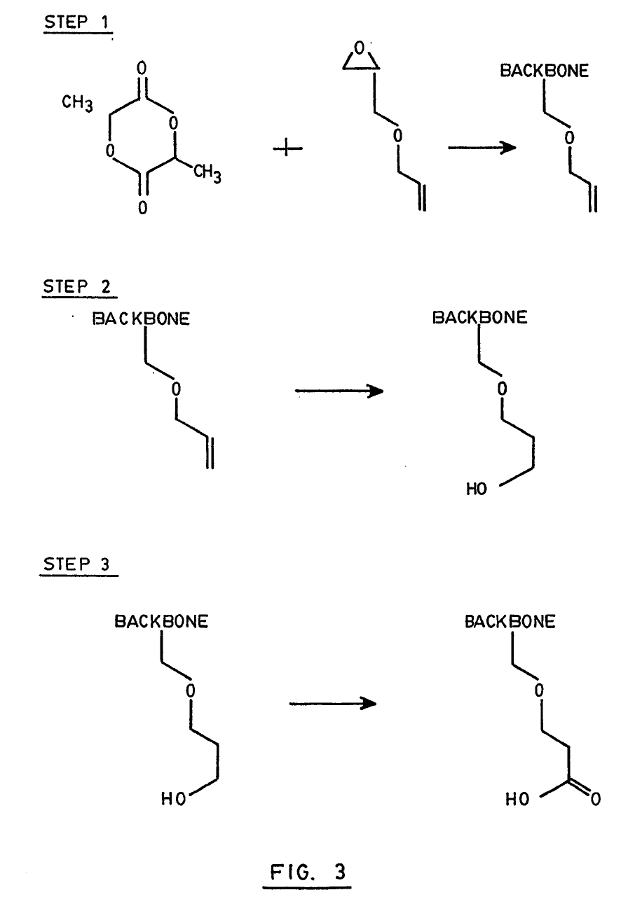

The whole process including the three above mentioned steps is illustrated in FIG. 3.

This process was actually repeated several times with different amounts of allyl glycidyl ether. The global yield of polymer was about 75% in each case.

The so prepared polymers were then characterized by gel permeation chromatography (GPC), nuclear magnetic resonance, (NMR) and differential scanning calorimetry (DSC).

Table 1 shows the glass transition temperature Tg of the so prepared polymers, as measured by DSC. Tg values are quite different from PLA which has a Tg of about 50° C. These data proves that despite the fact that the Tg is close to the room temperature, the polymers with 1% and 5% pendant groups can be used to prepare nanospheres and/or microspheres due to their high molecular weight.

TABLE 1

| | Allyl | Hydroxyl | Carboxylic |
|---|---|---|---|
| Pendant group | (step 1) | (step 2) | (step 3) |
| 1% | 27° C. | 38° C. | 31° C. |
| 5% | 20° C. | 26° C. | 34° C. |
| 20% | 13° C. | 16° C. | 24° C. |
| 30° C. | 18° C. | 17° C. | N/A |

Table 2 shows the molecular weights and polydispersity of the so prepared polymers. As can be noticed, the molecular weights of these polymers decreased when the percentages of allyl glycidyl ether were increased. As can also be noticed, addition of 1% of pendant groups does not affect the molecular weight (expressed in average in number Mn or average in weight Mw) as well as the polydispersity (I) significantly.

TABLE 2

| | Allyl | Hydroxyl | Carboxylic |
|---|---|---|---|
| Pendant group | (step 1) | (step 2) | (step 3) |
| 1% | Mn 19700 | Mn 21990 | Mn 14010 |
| | Mw 35060 | Mw 36390 | Mw 31190 |
| | I 1,780 | I 1,655 | I = 2,227 |
| 5% | Mn 71900 | Mn 3260 | Mn 5250 |
| | Mw 14900 | Mw 4270 | Mw 9170 |
| | I 2,072 | I 1,312 | I 1,747 |
| 20% | Mn 5340 | Mn 2780 G | Mn 2870 |
| | Mw 11390 | G | Mw 9170 |
| | I 2,133 | Mw 4410 | I 1,747 |
| | | I 1,589 | |
| 30% | Mn 3340 | Mn 2220 | N/A |
| | Mw 5350 | Mw 3220 | |
| | I 1,604 | I 1,454 | |

### EXAMPLE 2

Using substantially the same conditions of reaction as in example 1, functionalizable polymers were also prepared in using caprolactone, butyrolactone, dioxanone and cyclic diglycine as monomers (A).

### EXAMPLE 3

Some of the functionalizable polymers prepared in Example 1 were used as carriers for a ligand specific to Selectine E. Selectine E is known to be a white cell receptor expressed at the surface of the vascular endothelium in an early stage of adhesion during inflammation.

Grafting of the ligand to the functionalizable polymers was carried out using the following sequence of steps:
converting the free carboxylic groups of the functionalizable polymer to hydrochloride groups;
protecting all the reactive groups of the ligand;
selectively unprotecting one of said protected groups of the ligand so that it may react with the hydrochloride groups of the functionalizable polymer;
subjecting the partially unprotected ligand and the functionalizable polymer to esterification; and
unprotecting all the other reactive groups of the grafted ligand by catalytic hydrogenation.

The obtained functionalized polymer had the following formula:

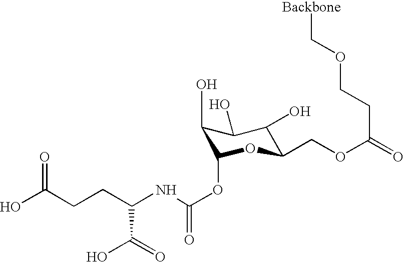

The average yield of the above process was about 55% and the molecular weights (Mw) of the so-obtained functionalized polymers was 42968 (1% grafting) and 18857 (5% grafting).

Then, microspheres were prepared with an emulsion solvent evaporation method. To visualize the microspheres and their capability of adhesion to vascular endothelium, these microspheres were labelled with color dyes.

More specifically, batches of microspheres were prepared, containing:
ungrafted polymer, β-carotene (#1);
grafted polymer 5%, Oil Blue N (#2);
grafted polymer 1%, β-carotene (#3).

150 mg of polymers were added to 1.5 ml of a 1% chloroforme solution of dye. The organic solution was poured drop wise in 100 ml of a 1% PVA solution under a high shear homogeniser for 3 min. After its formation, the emulsion was subjected to magnetic stirring for 2 h to evaporate the organic solvent. Microspheres were collected by centrifugation (5 min, 2000) and washed three times, (yield 87%). Microspheres were dried using a fast freeze dryer.

Mean diameter of microsphere batches were measured by image analysis using Zeiss® optical microscope mounted with a CDD digital camera. Image was grabbed by the Northern Eclipse® acquisition software and analyzed by Optimas 5® image analysis software.

Ex vivo experiments were done on mesenteric rat vessels. Rats were previously treated for three weeks with L-NAM (NO's inhibitor) before ex vivo experiment to be in chronic inflammatory condition.

Vessels were removed by surgery and immediately placed in a oxygenated Krebs solution at 37° C. Vessels were opened longitudinally and placed for 5 min into a suspension of microspheres (50% of polymer having ligand, 50% of polymer without ligand) in Krebs oxygenated solution. Tissues were rinsed for 5 min with a clear Krebs oxygenetad solution. Particle count and size measurements were done by optical microscopy and image analysis for each color.

Optical microscopy demonstrated that the microspheres consisting of the polymer with the ligand grafted on it adhered strongly to the endothelium. It also demonstrated that microspheres consisting of polymers without ligand were washed during the process and did not adhere.

Such is a clear indication that the bioadhesive drug carrier that was so prepared, can specifically target Selectine E at the endothelial surface and can therefore be of interest in the treatment of many pathology.

### EXAMPLE 4

Amphiphilic PEG-based polymers having the structural properties required for use as stealth drug carriers were also prepared. These carriers may be used to deliver an active substance during several weeks after their intravenous injection. In fact, these carriers differentiate from PEG-ylated liposomes due to their stability (solid matrix) and their covalent bonds.

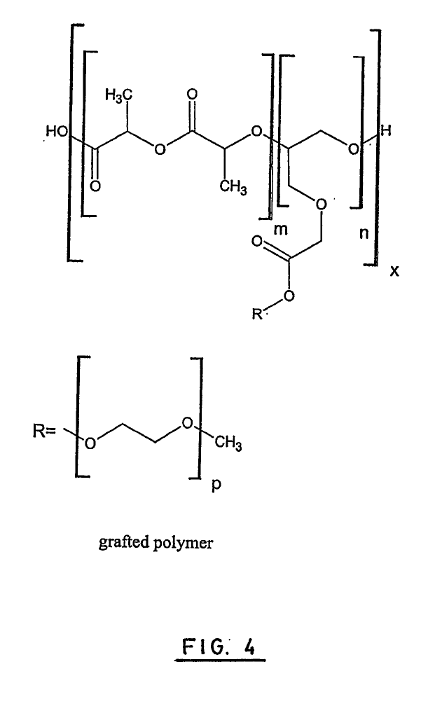

An example of such an amphiphilic methoxy-PEG-based polymer is illustrated in FIG. 4.

### EXAMPLE 5

Other PEG-based polymers having suitable properties for use as a cellular or tissue supports way prepared by grafting PLA to them.

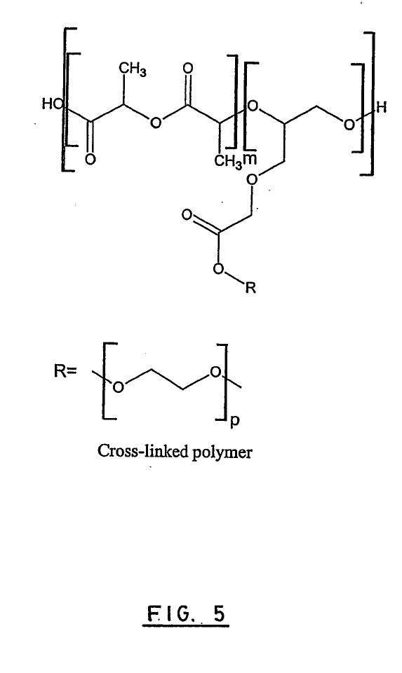

An example of such a polymer is illustrated in FIG. 5. It has the advantage of combining the structural features of PLA with the biological features of PEG.

### EXAMPLE 6

Orally administrable lipids were also prepared. Grafting of these lipids with palmitoleic acid was successfully tested. It can be presumed that nanospheres and/or microspheres having correctly chosen lipids on their surface would allow intestinal assimilation.

The above examples are indicative of the numerous potential applications of the present invention, due to the structure advantage of the functionalizable polymers of formula I, their capability to be easily grafted to active substances and the simplicity and efficiency of the process used for their preparation.

1. A functionalizable polymer of the formula I: 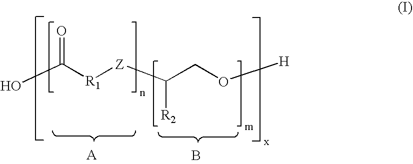
wherein:
Z is —O— or —NH—;
R₁ represents a non-functional backbone of a hydroxy acid or amino acid derived from a cyclic ester or diester or cyclic amide or diamide monomer (A);
R₂ represents a non-functional chain derived from an epoxide monomer (B), said chain ending with a graftable hydroxy or carboxylic group;
n is the number of units derived from the monomers (A);
m is the number of units derived from the monomers (B); and
x is equal to n+m;
the ratio m/x ranging from 0.005 to 0.30.

2. The functionalizable polymer of formula I as claimed in claim 1, wherein R1, R2, n, m and x are selected so that the average molecular weight of the polymer ranges from 1,000 to 50,000.

3. The functionalizable polymer of formula I as claimed in claim 1, wherein Z is —O— and the monomer A is selected from the group consisting of lactones, dioxanones and dioxanediones.

4. The functionalizable polymer of formula I as claimed in claim 3, wherein the monomer A is selected from the group consisting of caprolactone, glycolide, dilactide and glycolic lactide.

5. The functionalizable polymer of formula I as claimed in claim 1, wherein Z is —NH— and the monomer A is selected from the group consisting of lactams and dilactams.

6. The functionalizable polymer of formula I as claimed in claim 1, wherein the monomer B is selected from the group consisting of the epoxides of formula II: 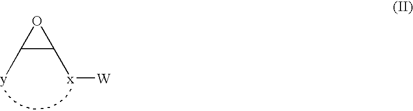
wherein:
X is a non-functional chain optionally containing one or more heteroatoms but no ester or amide link;
W is —CH₂CH₂OH or —CH₂COOH; and
Y is H, alkyl or phenyl;
X and Y being optionally linked to each other as shown in dotted lines.

7. The functionalizable polymer of formula I as claimed in claim 1, wherein the monomer B consists of alkyl glycidyl ether.

8. A process for preparing a functionalizable polymer of formula I as defined in claim 1, comprising the steps of:
a) reacting at least one monomer (A) with at least one epoxide of formula III 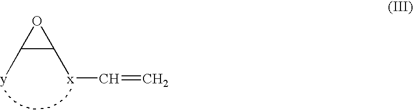
wherein X is a non-functional chain optionally containing one or more heteroatoms but no ester or amide link and wherein Y is H, alkyl or phenyl, in the presence of a catalyst;
b) subjecting the polymer obtained in step a) to an oxidation to convert the —CH═CH₂ groups into corresponding —CH₂CH₂OH groups; and
c) optionally subjecting the polymer obtained in step b) to another oxidation with a Jones mixture to convert the —CH₂CH₂OH groups into corresponding —CH₂COOH groups.

9. The process of claim 8, wherein:
step a) is carried out with a tin catalyst at a temperature higher than 100° C. under inert atmosphere.

10. The process of claim 8, wherein:
step b) is carried out under mild oxidation conditions.

11. The process of claim 10, wherein:
step b) is carried out by hydroboration at low temperature.

12. The process of claim 8, wherein the polymer obtained after each of the steps a) to c) are recovered and purified prior to being subjected to the next step.

13. A functionalized polymer consisting of a functionalizable polymer of the formula I as claimed, claim 1, to the graftable hydroxy or carboxylic groups of which has been grafted a compound selected from the group consisting of:
ligands specific to cellular receptors;
lipids;
polyethers;
polyacrylates;
natural polymers;
polyosides;
antigens or antibodies;
salen; and
cyclodextrins.

14. The functionalized polymer of claim 13, wherein the compound grafted to the polymer of formula II is a biomedically or pharmaceutically active substance.

15. The functionalized polymer of claim 14, wherein the compounds grafted to the polymer of formula I is a ligand specific to Selectine E.

16. The functionalized polymer of claim 13, which is in the form of nanospheres to facilitate delivery of the active substance.

17. A functionalized polymer consisting of a functionalizable polymer of the formula I prepared by the process as claimed in claim 8, to the graftable hydroxy or carboxylic groups of which has been grafted a compound selected from the group consisting of:
ligands specific to cellular receptors;
lipids;
peptides;
polyethers;
polyacrylates;
natural polymers;
polyosides;
antigens or antibodies;
salen; and
cyclodextrins.
